(19) United States
(12) Patent Application Publication
(10) Pub. No.: US 2026/0299984 A1
(43) Pub. Date: Oct. 1, 2026

(54) IN SERVICE MIGRATIONS IN MULTI-TENANT ENVIRONMENTS

(71) Applicant: Cisco Technology, Inc., San Jose, CA (US)

(72) Inventors: Parthasarathi Dukka, Santa Clara, CA (US); Srilatha Tangirala, San Jose, CA (US); Karthik Kumar Thatikonda, Dublin, CA (US); Ajeet Pal Singh Gill, Fremont, CA (US); Sheikh M. Qumruzzaman, Santa Clara, CA (US)

(21) Appl. No.: 19/090,539

(22) Filed: Mar. 26, 2025

(51) Int. Cl. G06F 9/455

(52) U.S. Cl. CPC G06F 9/45558; G06F 2009/4557

(57) ABSTRACT

In one aspect, a computer-implemented method may include storing, by a multi-tenant management component of a communication network and at a database associated with the communication network, mapping information associated with a tenant and a first controller pair. The tenant may include a first number of devices being managed by the first controller pair. The method may further include receiving a request for onboarding a second number of devices associated with the tenant. The first number of devices and the second number of devices combined may exceed a first load capacity of the first controller pair. The method may further include identifying a second controller pair having a second load capacity sufficient to accommodate the second number of devices and managing seamless migration of the first number of devices and the second number of devices to the second controller pair.

### TECHNICAL FIELD

The present technology pertains to multi-tenanted networks, and, more specifically, to tenant migration between controller pairs on a multi-tenanted network.

### BACKGROUND

In multi-tenanted network environments, tenant migration refers to the process of transferring a tenant's data, configurations, and associated resources from one network controller to another. This functionality is crucial for maintaining network scalability, ensuring load balancing, and facilitating hardware or software upgrades without service disruption. Migration typically involves preserving tenant-specific attributes such as security policies, access permissions, and quality-of-service (QoS) configurations while ensuring minimal downtime and consistent connectivity. Effective tenant migration strategies are essential for supporting dynamic network environments, particularly in software-defined networking (SDN) architectures, where tenants require seamless control and performance across distributed controllers. Challenges include maintaining data integrity, synchronizing state information, and ensuring compliance with privacy and security standards during the migration process.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture according to some aspects of the present disclosure.

FIG. 2 illustrates an example of tenant migration between controller pairs on a multi-tenanted network according to some aspects of the present disclosure.

FIG. 3 illustrates an example flowchart for tenant migration between controller pairs according to some aspects of the present disclosure.

FIG. 4 shows an example of a computing system for implementing certain aspects of the present technology according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### OVERVIEW

In one aspect, a computer-implemented method may include storing, by a multi-tenant management component of a communication network and at a database associated with the communication network, mapping information associated with a tenant and a first controller pair. The tenant may include a first number of devices being managed by the first controller pair. The method may further include receiving a request for onboarding a second number of devices associated with the tenant. The first number of devices and the second number of devices combined may exceed a first load capacity of the first controller pair. The method may further include identifying a second controller pair having a second load capacity sufficient to accommodate the second number of devices and managing seamless migration of the first number of devices and the second number of devices to the second controller pair.

In another aspect, the validator may periodically purge one or more inactive devices associated with the tenant from the multi-tenanted communication network.

In another aspect, the first controller pair may be in a migration mode that allows the second controller pair to learn routes associated with the first number of devices.

In another aspect, the second controller pair may form a mesh with the first controller pair to learn existing routes between the first controller pair and the first number of devices.

In another aspect, upon completion of the mesh, the first controller pair may send a notification to the first number of devices of addition of the second controller pair.

In another aspect, managing the seamless migration may further include receiving a message from the first number of devices triggered by the notification. The method may further include transmitting a register-reply message to the first number of devices, the register-reply message may include a corresponding capacity on each controller of the first controller pair and the second controller pair.

In another aspect, managing the seamless migration may further include receiving a signal from the first controller pair indicating completion of migration of the first number of devices and the second number of devices to the second controller pair and terminating connections between the first number of devices and the second number of devices of the tenant and the first controller pair.

In another aspect, each device of the first number of devices and the second number of devices establishes a connection to the second controller pair before tearing down a corresponding existing connection to the first controller pair.

In another aspect, the connection and the corresponding existing connection are control plane connection.

In one aspect, a system, comprising of one or more processors and a memory storing instructions that, when executed by the one or more processors, configure the system to store, by a multi-tenant management component of a communication network and at a database associated with the communication network, mapping information associated with a tenant and a first controller pair. The tenant may include a first number of devices being managed by the first controller pair. The system may further receive a request for onboarding a second number of devices associated with the tenant. The second number of devices may be greater than the first number of devices and may exceed a first load capacity of the first controller pair. The system may further identify a second controller pair having a second load capacity sufficient to accommodate the second number of devices and manage seamless migration of the first number of devices and the second number of devices to the second controller pair. In one aspect, a non-transitory computer-readable storage medium, the non-transitory computer-readable storage medium including instructions that, when executed by a computer, cause the computer to store, by a multi-tenant management component of a communication network and at a database associated with the communication network, mapping information associated with a tenant and a first controller pair. The tenant may include a first number of devices being managed by the first controller pair. The computer may further receive a request for onboarding a second number of devices associated with the tenant. The second number of devices may be greater than the first number of devices and may exceed a first load capacity of the first controller pair. The computer may further identify a second controller pair having a second load capacity sufficient to accommodate the second number of devices and manage seamless migration of the first number of devices and the second number of devices to the second controller pair. Other technical features may be readily apparent to one skilled in the art from the following figures, descriptions, and claims.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In a Cloud Delivered Catalyst SD-WAN (CDCS) network, when a tenant is onboarded onto a network manager with a default load capacity (e.g., 50 devices), the network manager looks at the available capacity on controllers in the network and onboards the tenant onto a pair of controllers. When the tenant wants to expand their network by adding more devices, the controller placement may need to be recalculated based on the additional capacity required. On the controller pair, there may or may not be enough resources (with respect to DTLS control connections, RIB ins, and RIB outs) to accommodate the newly added devices or sites of the tenant. If there are not enough resources, there would be disruption in the network. If there is no additional capacity on the controller pair assigned to the tenant, the tenant may need to be migrated seamlessly to a second pair of controllers without causing any network disruption.

In some examples, to avoid the migration, more controllers can be added for tenant and the newly added devices can be assigned to these new controllers. However, this method would result in more controller peerings and more routes exchanging, thereby resulting in higher resource utilization and increased operations to manage a greater number of controllers. With the aforementioned method, if multiple tenants are scaling up at the same time, the existing controllers may process more routes from the other controllers due to the full mesh peering. The controller pairs would not have enough resources for handling such dynamic network growth and not handling such situations could cause network outages.

The problems mentioned in the above section are solved by onboarding the tenant on a higher capacity controller pair using the following method or procedure to ensure seamless migration without any disruption to the service. When the tenant is initially onboarded onto the network, the tenant may be assigned a first controller pair. A manager associated with the network (e.g., vManage, MT Manager, etc.) may populate a database associated with the tenant with tenant to controller mapping to indicate that the first controller pair is associated with the tenant. This database may be associated with a validator (e.g., vBond) of the network. If/when the tenant indicates that the tenant network will be expanded (e.g., by adding more devices) in a manner that exceeds the load capacity of the first controller pair, a second controller pair may be selected by the network that has a larger load capacity than the first controller pair. The tenant may be onboarded onto the second controller pair. To begin the onboarding, the second controller pair may form a full mesh peering with the first controller pair. The second controller pair may learn the routes from the first controller pair for the pre-existing devices associated with the network (e.g., not the new devices that the tenant is planning on adding). The first controller pair may signal the pre-existing devices regarding the second controller pair and the respective higher capacity. This signaling may include a tenant digest.

The receipt of the tenant digest may initiate the pre-existing devices to signal the validator, despite the pre-existing devices being in equilibrium. The validator may transmit a register-reply of the second set of controllers to the pre-existing devices and to the newly-added devices of the tenant. The devices of the tenant will likely prefer the higher capacity of the second set of controllers. To avoid disruption, the devices of the tenant will first establish a control connection to the second controller pair and then proceed to tear down the control connection to the first controller pair. Once the tenant devices are all migrated to the second controller pair, the first controller pair may signal to the manager that the tenant has been fully migrated. The first controller pair may be used for a second tenant upon full migration.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

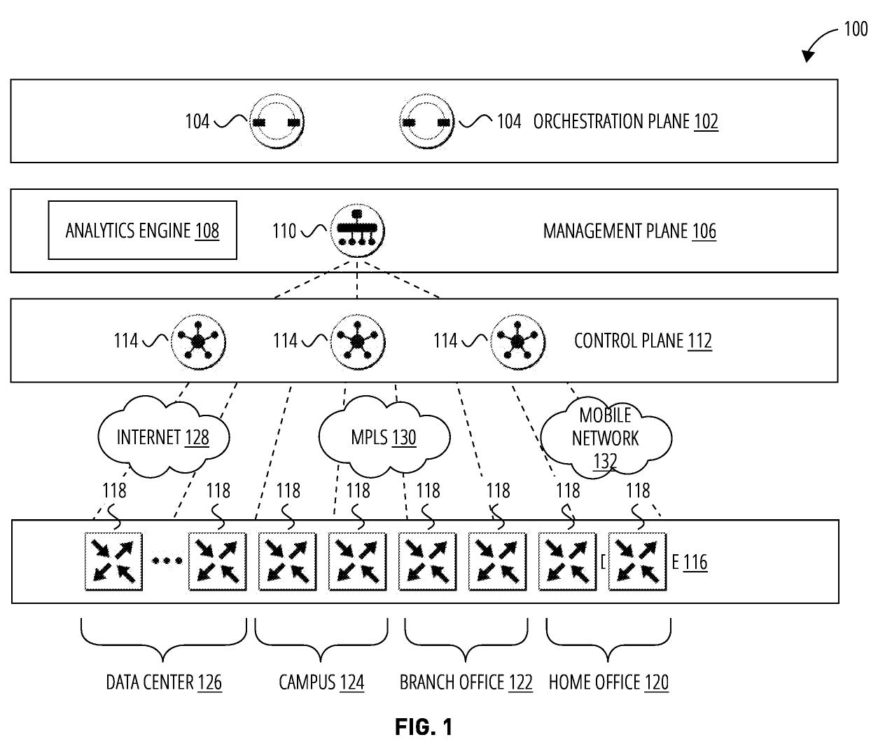

FIG. 1 illustrates an example of a high-level network architecture according to some aspects of the present disclosure. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110. In some examples, the management plane 106 may include analytics engine 108, which may analyze, monitor, and optimize network performance and operations. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

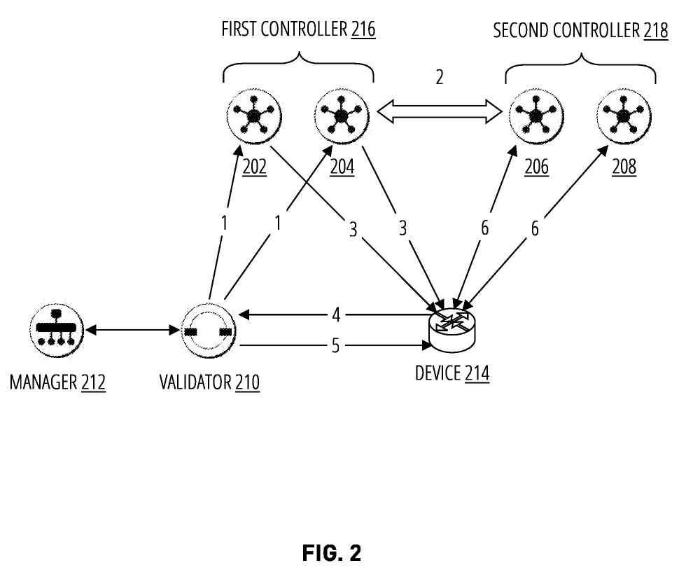

FIG. 2 illustrates an example of tenant migration between controller pairs on a multi-tenanted network according to some aspects of the present disclosure. The multi-tenanted network may include one or more tenants (e.g., enterprises, clients, organizations, etc.) that may require tenant isolation. The client devices (may also be referred to as end devices, terminals, or simply devices that include, but are not limited to, any known or to be developed computing device capable of establishing wired and/or wireless connection over a wired and/or wireless network) associated with each of the one or more tenants may be hosted on respective controller pairs. For example, client devices associated with a first tenant may be associated with a first controller pair, while client devices associated with a second tenant may be associated with a second controller pair. The traffic associated with the first tenant and the second tenant may remain isolated from one another, thereby maintaining security and privacy between tenants. The multi-tenanted network may include associated components, including, but not limited to, one or more controller pairs (e.g., first controllers 216 and second controllers 218), manager 212, and validator 210. In some examples, manager 212 may be the same as a vManage of an SD-WAN network, validator 210 may be the same as a vBond of an SD-WAN network, and first and second controller pairs may be the same as a vSmart of an SD-WAN network (Each may also be referred to as a network management component/controller of a multi-tenanted network), such as an SD-WAN network as described in FIG. 1. The multi-tenant management component may operate centrally (e.g., one physical network component/controller may perform the functionalities of both manager 212 and validator 210, and optionally a vSmart) or in a distributed manner and may execute computer-readable instructions to perform functionalities and operations described herein. Manager 212 may populate a database in a location accessible to components associated with the multi-tenanted network (e.g., validator 210, first controllers 216, second controllers 218, etc.) with tenant-to-controller mapping information. For example, the database may include mapping information associated with a first tenant and a first controller pair. In some examples, the database may be stored on validator 210 such that validator 210 may enforce that incoming data, requests, or transactions meet the defined rules and access controls for each tenant of the multi-tenanted network, thereby ensuring correct routing and preventing cross-tenant interference. Manager 212 may periodically purge the database of inactive devices associated with the first tenant. This may reduce the capital expenditure and operating expenditure of the first tenant and provide optimized network management.

In some examples, tenants may require additional tenants that may be serviced by a controller pair. For example, a tenant may add new employees, a tenant may utilize a larger building with more overhead, a tenant may add a new service that requires additional devices connected to the multi-tenanted network (e.g., a security service), a tenant may add new devices to the multi-tenanted network (e.g., upgrading a phone system), any combination thereof, or the like. In these scenarios, the tenant may require an upgraded controller pair that has capacity and capability to service an increased number of devices. For example, the tenant may increase the number of devices connected to the multi-tenanted network from 50 devices to 200 devices. When the tenant wants to expand their network and increase the number of devices connected to the multi-tenanted network, and there is not enough available resources on the current controller pair, connectivity may be disrupted. The tenant can be seamlessly migrated to the upgraded controller pair without causing network disruption.

For example, device 214 may be associated with a tenant connected to a multi-tenanted network. At step 1, device 214 may be connected to first controllers 216, which may be comprised of at least two controllers, controller 202 and controller 204. In some examples, controller 202 and controller 204 may be vSmart controllers associated with an SD-WAN network, as described in FIG. 1. The tenant may indicate an increase in a number of devices associated with the tenant (e.g., signaling to first controllers 216, signaling to manager 212, any combination thereof, or the like). Manager 212 may identify a pair of new controllers, other than first controllers 216, that may accommodate the increased number of devices associated with the tenant. For example, second controllers 218 (which may be comprised of at least two controllers, controller 206 and controller 208) may be identified to host device 214 and other devices (including new devices to be added) associated with the tenant on the multi-tenanted network. In some examples, controller 206 and controller 208 may be vSmart controllers associated with an SD-WAN network, as described in FIG. 1.

At step 2, second controllers 218 may form a full mesh peering with first controllers 216. Full mesh peering is a network topology in which each node (e.g., controller 206 and controller 208) establishes a direct logical or physical connection with every other node (e.g., controller 202 and controller 204), enabling bidirectional communication between the two pairs of controllers without relying on intermediary nodes, thereby maximizing connectivity and minimizing transmission latency at the expense of increased link overhead and scalability challenges. In some examples, first controllers 216 may be in a “migration mode.” The migration mode allows the controllers to learn the existing routes associated with the tenant. Additionally, the migration mode may prevent new devices associated with the tenant from onboarding onto the multi-tenanted network during the full-mesh peering. Using the full mesh peering, second controllers 218 may learn the routes associated with device 214 and other devices associated with the tenant that currently exist on the multi-tenanted network (e.g., the original 50 devices, including device 214, that are currently associated with the tenant).

At step 3, first controllers 216 may signal device 214, and other devices that currently exist on the multi-tenanted network, indicating the migration to second controllers 218. This signal may include the increased capacity of second controllers. This signal may also include a tenant digest from first controllers 216, which may be a compact, cryptographic summary of the tenant's configuration, metadata, or state within the multi-tenanted network, which may be used for verification, synchronization, or security purposes. In some examples, first controllers 216 may no longer be associated with a “migration mode” when signaling the tenant digest to device 214.

At step 4, based on a configuration associated with the multi-tenanted network, receipt of the tenant digest may automatically trigger a transmission from device 214 to validator 210, despite device 214 being in equilibrium. For example, the pre-existing devices (e.g., device 214) may be operating in a stable state where associated resources (e.g., bandwidth, memory, processing power, etc.) are utilized without overloading and/or underutilizing. Thus, in equilibrium, device 214 may not signal validator 210 without receiving the tenant digest because signaling validator 210 may disrupt the stable state of device 214 (e.g., introducing additional use of associated resources, increasing latency and/or congestion, increasing risk of instability, etc.). Further, in some examples, signaling validator 210 is unnecessary due to existing trust in the current state and/or current operation of the multi-tenanted network.

At step 5, validator 210 may send a register-reply to device 214. The register-reply may include an allocated capacity of first controllers 216 and/or second controllers 218. For example, the register-reply may include an indication that first controllers 216 (controller 202 and controller 204) have capacity for 50 devices, while second controllers 218 (e.g., controller 206 and controller 208) have capacity for 200 devices, either individually or in sum (e.g., controller 202 may have a capacity for 50 devices and controller 204 may have a capacity for 50 devices, or the total capacity of controller 202 and controller 204 in combination is 50 devices).

At step 6, device 214 may establish a connection with second controllers 218 and sever a connection with first controllers 216. To avoid service disruption, device 214 may first establish the connection with second controllers 218 before tearing down the connection with first controllers 216. The current devices associated with the tenant, including device 214, may signal manager 212 that the tenant has been fully migrated to second controllers 218 and is no longer associated with first controllers 216. Manager 212 may release first controllers 216 and repurpose first controllers 216 for other tenants associated with the multi-tenanted network. Manager 212 may update the database associated with validator 210 to include mapping information associated with the tenant and second controllers 218.

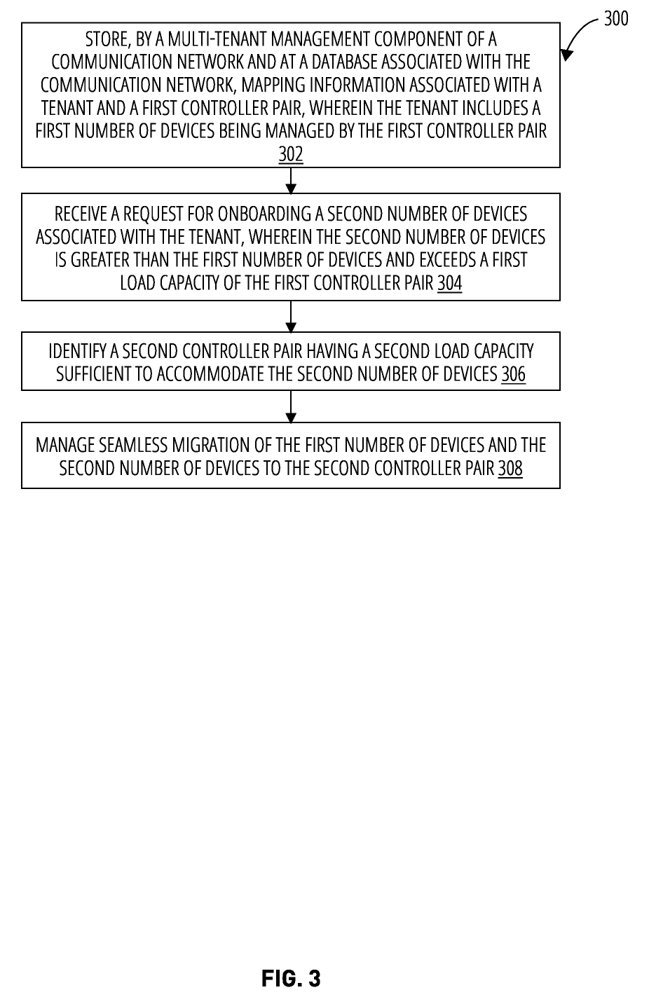

FIG. 3 illustrates an example flowchart for tenant migration between controller pairs according to some aspects of the present disclosure. In block 302 of method 300, a multi-tenant management component of a communication network and at a database associated with the communication network, mapping information associated with a tenant and a first controller pair, where the tenant includes a first number of devices being managed by the first controller pair. For example, manager 212 (described in FIG. 2) may store, at a database associated with the communication network, mapping information associated with a tenant and first controllers 216 (described in FIG. 2), where the tenant includes a first number of devices being managed by first controllers 216. The first number of devices may include devices (e.g., personal computers, laptops, desktop computers, tablets, printers, cell phones, fax machines, cameras, speakers, etc.) associated with the tenant that are connected to the multi-tenanted communication network. In some examples, the manager associated with the multi-tenanted communication network may populate the database at a validator. The database may be stored in a location accessible to the validator and/or the manager. The database may be updated periodically and may be purged of inactive devices associated with the tenant.

In block 304 of method 300, the multi-tenant management component may receive a request for onboarding a second number of devices associated with the tenant, where the first number of devices and the second number of devices combined exceeds a first load capacity of the first controller pair. In some examples, the second number of devices may be less than the first number of devices (e.g., the first number of devices is 50 and the second number of devices is 25). In some other examples, the second number of devices may be more than the first number of devices (e.g., the first number of devices is 50 and the second number of devices is 75). In yet some other examples, the second number of devices, alone or combined with first number of devices, may exceed the first load capacity of the first controller pair (e.g., the second number of devices is 100 and the first load capacity is 65). For example, manager 212 may receive the request for onboarding a second number of devices associated with the tenant, where the first number of devices and the second number of devices combined exceeds a first load capacity of first controllers 216. The tenant may add a new service that requires additional devices connected to the multi-tenanted network (e.g., a security service), a tenant may add new devices to the multi-tenanted network (e.g., upgrading a phone system), any combination thereof, or the like. This may increase the amount of devices associated with the tenant beyond the capabilities of the first controller pair. Tenant may notify the manager associated with the multi-tenanted communication network of the new devices (e.g., the second number of devices).

In block 306 of method 300, the multi-tenant management component may identify a second controller pair having a second load capacity sufficient to accommodate the second number of devices. For example, manager 212 may identify second controllers 218 (described in FIG. 2) having the second load capacity sufficient to accommodate the second number of devices.

In block 308 of method 300, the multi-tenant management component may manage seamless migration of the first number of devices and the second number of devices to the second controller pair. For example, manager 212 may manage seamless migration of the first number of devices and the second number of devices to second controllers 218. The second controller pair may form the full mesh peering with the first controller pair after being associated with a “migration mode.” The migration mode allows the controllers to learn the existing routes associated with the tenant. The second controller pair may learn the routes associated with the tenant via the full mesh peering, then the first controller pair may disassociate with the “migration mode.” The first controller pair may then signal the first number of devices, which may include the tenant digest and an indication of the increased capacity of the second controller pair. The signal may also indicate the completion of the migration of the first number of devices and the second number of devices to the second controller pair. The first number of devices, in response to receiving the tenant digest, may transmit a transmission of the one or more signals. This may occur even if the one or more devices are in equilibrium.

In some examples, the multi-tenant management component may update the database associated with the multi-tenanted communication network to include mapping information associated with the tenant and the second controller pair, wherein the tenant includes the second number of devices.

In some examples, the multi-tenant management component may transmit a reply signal to the devices. The reply signal may include an allocated capacity of the first controller pair and/or the second controller pair. Each device of the first number of devices and the second number of devices may terminate a connection between the tenant and the first controller pair. In some examples, each device of the first number of devices and the second number of devices may establish a connection to the second controller pair before tearing down existing connections to the first controller pair. In some examples, the multi-tenant management component may periodically purge one or more inactive devices associated with the tenant from the multi-tenanted communication network.

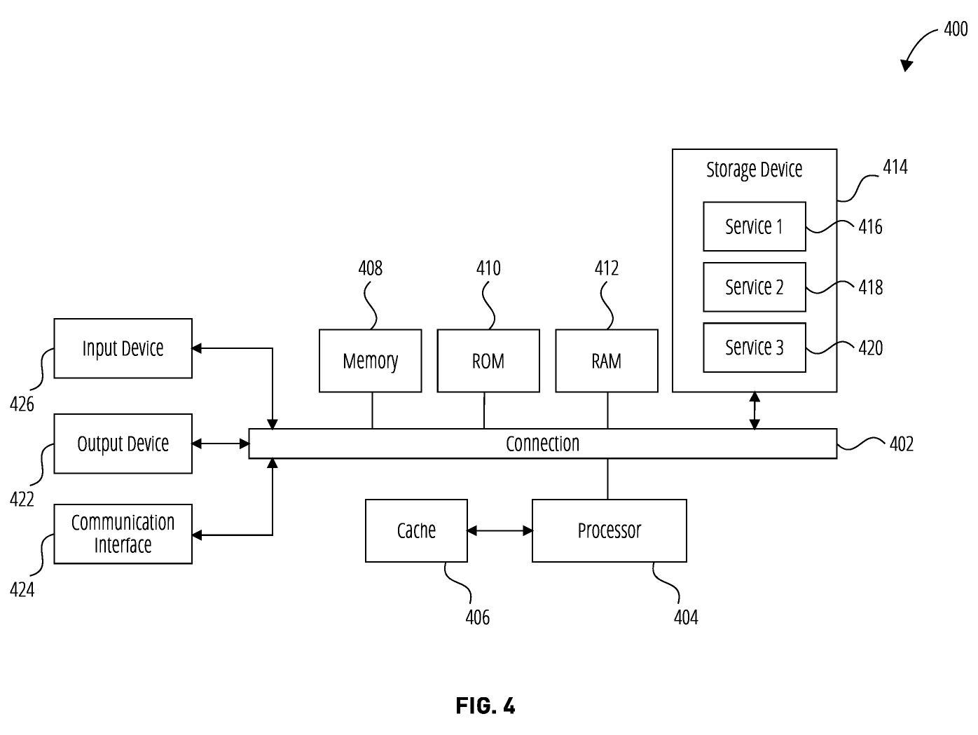

FIG. 4 shows an example of a computing system for implementing certain aspects of the present technology according to some aspects of the present disclosure. For example, FIG. 4 shows an example of computing system 400, which can be for example any computing device making up FIG. 1, FIG. 2, FIG. 3, and/or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit (CPU or processor) 404 and connection 402 that couples various system components including system memory 408, such as read-only memory (ROM) 410 and random-access memory (RAM) 412 to processor 404. Computing system 400 can include a cache of high-speed memory 406 connected directly with, in close proximity to, or integrated as part of processor 404.

Processor 404 can include any general-purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
storing, by a multi-tenant management component of a communication network and at a database associated with the communication network, mapping information associated with a tenant and a first controller pair, wherein the tenant includes a first number of devices being managed by the first controller pair;
receiving a request for onboarding a second number of devices associated with the tenant, wherein the first number of devices and the second number of devices combined exceeds a first load capacity of the first controller pair;
identifying a second controller pair having a second load capacity sufficient to accommodate the second number of devices; and
managing seamless migration of the first number of devices and the second number of devices to the second controller pair.

2. The computer-implemented method of claim 1, wherein the second controller pair forms a mesh with the first controller pair to learn existing routes between the first controller pair and the first number of devices.

3. The computer-implemented method of claim 2, wherein upon completion of the mesh, the first controller pair sends a notification to the first number of devices of addition of the second controller pair.

4. The computer-implemented method of claim 3, wherein managing the seamless migration comprises:
receiving a message from the first number of devices triggered by the notification; and
transmitting a register-reply message to the first number of devices, the register-reply message including a corresponding capacity on each controller of the first controller pair and the second controller pair.

5. The computer-implemented method of claim 4, wherein managing the seamless migration further comprises:
receiving a signal from the first controller pair indicating completion of migration of the first number of devices and the second number of devices to the second controller pair; and
terminating connections between the first number of devices and the second number of devices of the tenant and the first controller pair.

6. The computer-implemented method of claim 5, wherein each device of the first number of devices and the second number of devices establishes a connection to the second controller pair before tearing down a corresponding existing connection to the first controller pair.

7. The computer-implemented method of claim 1, further comprising:
periodically purging one or more inactive devices associated with the tenant from the communication network.

8. A system comprising:
one or more processors; and
a memory storing instructions that, when executed by the one or more processors, configure the system to:
store, by a multi-tenant management component of a communication network and at a database associated with the communication network, mapping information associated with a tenant and a first controller pair, wherein the tenant includes a first number of devices being managed by the first controller pair;
receive a request for onboarding a second number of devices associated with the tenant, wherein the first number of devices and the second number of devices combined exceeds a first load capacity of the first controller pair;
identify a second controller pair having a second load capacity sufficient to accommodate the second number of devices; and
manage seamless migration of the first number of devices and the second number of devices to the second controller pair.

9. The system of claim 8, wherein the second controller pair forms a mesh with the first controller pair to learn existing routes between the first controller pair and the first number of devices.

10. The system of claim 9, wherein upon completion of the mesh, the first controller pair sends a notification to the first number of devices of addition of the second controller pair.

11. The system of claim 10, wherein manage the seamless migration comprises:
receive a message from the first number of devices triggered by the notification; and
transmit a register-reply message to the first number of devices, the register-reply message including a corresponding capacity on each controller of the first controller pair and the second controller pair.

12. The system of claim 11, wherein manage the seamless migration further comprises:
receive a signal from the first controller pair indicating completion of migration of the first number of devices and the second number of devices to the second controller pair; and
terminate connections between the first number of devices and the second number of devices of the tenant and the first controller pair.

13. The system of claim 12, wherein each device of the first number of devices and the second number of devices establishes a connection to the second controller pair before tearing down a corresponding existing connection to the first controller pair.

14. The system of claim 8, wherein the instructions further configure the system to:
periodically purge one or more inactive devices associated with the tenant from the communication network.

15. A non-transitory computer-readable storage medium, the non-transitory computer-readable storage medium including instructions that when executed by a computer, cause the computer to:
store, by a multi-tenant management component of a communication network and at a database associated with the communication network, mapping information associated with a tenant and a first controller pair, wherein the tenant includes a first number of devices being managed by the first controller pair;
receive a request for onboarding a second number of devices associated with the tenant, wherein the first number of devices and the second number of devices combined exceeds a first load capacity of the first controller pair;
identify a second controller pair having a second load capacity sufficient to accommodate the second number of devices; and
manage seamless migration of the first number of devices and the second number of devices to the second controller pair.

16. The non-transitory computer-readable storage medium of claim 15, wherein the second controller pair forms a mesh with the first controller pair to learn existing routes between the first controller pair and the first number of devices.

17. The non-transitory computer-readable storage medium of claim 16, wherein upon completion of the mesh, the first controller pair sends a notification to the first number of devices of addition of the second controller pair.

18. The non-transitory computer-readable storage medium of claim 17, wherein manage the seamless migration comprises:
receive a message from the first number of devices triggered by the notification; and
transmit a register-reply message to the first number of devices, the register-reply message including a corresponding capacity on each controller of the first controller pair and the second controller pair.

19. The non-transitory computer-readable storage medium of claim 18, wherein manage the seamless migration further comprises:
receive a signal from the first controller pair indicating completion of migration of the first number of devices and the second number of devices to the second controller pair; and
terminate connections between the first number of devices and the second number of devices of the tenant and the first controller pair.

20. The non-transitory computer-readable storage medium of claim 19, wherein each device of the first number of devices and the second number of devices establishes a connection to the second controller pair before tearing down a corresponding existing connection to the first controller pair.
